(19) United States
(12) Patent Application Publication
(10) Pub. No.: US 2008/0157670 A1
(43) Pub. Date: Jul. 3, 2008

(54) PLASMA DISPLAY PANEL AND METHOD OF MANUFACTURING THE SAME

(75) Inventors: Dongki PAIK, Yongin-si (KR); Kwang Yeol Choi, Osan-si (KR); Jongrae Lim, Anyang-si (KR); Wootae Kim, Yongin-si (KR); Sung Chun Choi, Anyang-si (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/618,262

(22) Filed: Dec. 29, 2006

(51) Int. Cl. H01J 17/49; H01J 9/02

(52) U.S. Cl. 313/586; 445/24

(57) ABSTRACT

A plasma display panel and a method of manufacturing the plasma display panel are disclosed. The plasma display panel includes a scan electrode, a sustain electrode, and a barrier rib formed on a glass, and an upper dielectric layer having a differential thickness formed on the glass. The upper dielectric layer covers the scan electrode and the sustain electrode. As the upper dielectric layer is far away from a discharge region portion between the scan electrode and sustain electrode, the width of the upper dielectric layer gradually increases. A distance between the scan electrode and the sustain electrode positioned within a discharge cell partitioned by the barrier rib is more than a height of the barrier rib.

### BACKGROUND

1. Field

This document relates to a plasma display panel and a method of manufacturing the same.

2. Description of the Related Art

In general, a plasma display panel has a front substrate and a rear substrate. A barrier rib formed between the front substrate and the rear substrate forms one unit cell. Each cell is filled with an inert gas containing a primary discharge gas, such as neon (Ne), helium (He) or a mixed gas of Ne+He, and a small amount of xenon (Xe). If the inert gas is discharged with a high frequency voltage, it generates vacuum ultraviolet rays. The inert gas excites phosphors formed between the barrier ribs, so that images are implemented. The plasma display panel can be made thin and light, and has thus been in the spotlight as the next-generation display devices.

FIG. 1 is a perspective view schematically showing the construction of a related art plasma display panel.

As illustrated in FIG. 1, the plasma display panel has a front substrate 100 and a rear substrate 110, which are parallel to each other with a gap therebetween. In the front substrate 100, a plurality of sustain electrode pairs in which scan electrodes 102 and sustain electrodes 103 are formed in pairs are arranged on a front glass 101 serving as a display surface on which images are displayed. In the rear substrate 110, a plurality of address electrodes 113 crossing the plurality of sustain electrode pairs are arranged on a rear glass 111 serving as a rear surface.

The front substrate 100 has the pairs of scan electrodes 102 and sustain electrodes 103, which mutually discharge the other within one discharge cell and sustain the emission of the cell. In other words, each of the scan electrode 102 and the sustain electrode 103 has a transparent electrode “a” formed from transparent ITO material and a bus electrode “b” formed from metal material. The scan electrodes 102 and the sustain electrodes 103 are covered with one or more dielectric layers 104 serving to limit a discharge current and provide insulation between the electrode pairs. A protection layer 105 having Magnesium Oxide (MgO) deposited thereon is formed on a top surface of the dielectric layers 104 in order to facilitate discharge conditions.

In the rear substrate 110, barrier ribs 112 of a stripe type (or a well type), for forming a plurality of discharge spaces, that is, discharge cells are arranged in parallel. Further, a plurality of address electrodes 113, which generate vacuum ultraviolet rays by performing an address discharge, are disposed parallel to the barrier ribs 112. R, G and B phosphor layers 114 that radiate a visible ray for displaying images at the time of the address discharge are coated on a top surface of the rear substrate 110. A dielectric layer 115 for protecting the address electrodes 113 is formed between the address electrodes 113 and the phosphor layers 114.

As described above, the plasma display panel is completed through a sealing process for coalescing the front panel and the rear panel after the front panel manufacturing process and the rear panel manufacturing process are performed. A process of forming the front panel and the rear panel is described in more detail with reference to FIG. 2.

FIG. 2 is a flowchart illustrating a method of manufacturing the related art plasma display panel.

As illustrated in FIG. 2, the method of manufacturing the related art plasma display panel comprises a front panel manufacturing process shown on the left side of FIG. 2, a rear panel manufacturing process shown on the right side of FIG. 2, and an assembly process comprising a sealing process, etc. shown at the bottom of FIG. 2.

The front panel manufacturing process shown on the left side of FIG. 2 is first described below.

In the front panel, after the front glass is prepared (100), the plurality of sustain electrode pairs are formed on the front glass (110). Thereafter, the upper dielectric layer is formed on the sustain electrode pairs (120). The protection layer formed from MgO for protecting the sustain electrode pairs is formed on the upper dielectric layer (130).

The rear panel manufacturing process shown on the right side of FIG. 2 is described below.

In the rear panel, in the same manner as the front panel, the rear glass is first prepared (200). The plurality of address electrodes crossing the sustain electrode pairs formed in the front panel are formed in the rear glass (210). Thereafter, the lower dielectric layer is formed to cover the address electrodes (220). The barrier ribs are formed on a top surface of the lower dielectric layer (230). The phosphor layer is formed in the discharge spaces between the barrier ribs (240).

The front panel and the rear panel fabricated as described above are coalesced (300) to form the plasma display panel (400).

The manufacturing process of the front panel in the method of manufacturing the related art plasma display panel is described in more detail below with reference to FIG. 3.

FIG. 3 is a cross-sectional view illustrating a method of manufacturing a front panel as an example of the related art plasma display panel.

As illustrated in FIG. 3, at step (a), a transparent electrode 301 made of Indium Tin Oxide (ITO) comprising indium oxide and zinc oxide is formed on a front glass 300.

An example of a method of forming the transparent electrode 301 is described below. A Dry Film Photo Resist (DFR) is laminated on the transparent electrode layer made of ITO to form a pattern of a photomask. Development and etching processes are performed to form a transparent electrode 301a for scan and a transparent electrode 301b for sustain.

At step (b), black paste for forming a black layer 302 is printed on the front glass 300 on which the transparent electrode 301a for scan and the transparent electrode 301b for sustain are formed. The black paste is dried at a temperature of about 120 degrees Celsius. At step (c), a photomask 305 having a pattern formed therein is placed on the dried black paste and is then dried by irradiating it with ultraviolet rays. This process is called photolithography.

At step (d), silver (Ag) paste 303 is coated and printed on the black layer 302 that has experienced the photolithography process in order to form bus electrodes 303a and 303b, and is then dried.

At step (e), a photomask 306 having a pattern formed therein is placed on the coated silver (Ag) paste 303 and experiences a photolithography process. At step (f), a portion of the coated silver (Ag) paste 303 that has not been hardened is developed and then sintered in a sintering furnace (not shown) at a temperature of about 550 degrees Celsius for about 3 hours, thus forming the bus electrode 303a for scan and the bus electrode 303b for sustain.

At step (g), an upper dielectric layer 307 is formed on the front glass 300 on which the scan electrodes 301a and 303a and the sustain electrodes 301b and 303b are formed. At this time, the upper dielectric layer 307 is a differential dielectric layer, and is therefore differentially formed in the discharge gap portion between the transparent electrode 301a for scan and the transparent electrode 303a for sustain.

An example of a method of forming the upper dielectric layer 307 having a differential thickness is described below. A dielectric glass paste is coated and dried, and is then sintered in a temperature range of about 500 to 600 degrees Celsius, forming an upper dielectric layer.

At step (h), a protection layer 308 made of MgO is formed on a surface of the upper dielectric layer 307 by means of a CVD method, an ion plating method, a vacuum deposition method or the like. The front panel of the plasma display panel is thereby completed.

The differential dielectric layer, as an example of the plasma display front panel, is described in more detail below with reference to FIG. 4.

FIG. 4 is a view illustrating an upper dielectric layer having a differential thickness as an example of the related art plasma display panel.

As illustrated in FIG. 4, in the related art plasma display front panel, a scan electrode 401 and a sustain electrode 403 are formed on a front glass 400. An upper dielectric layer 407 for limiting the discharge current between the scan electrode 401 and the sustain electrode 403 and insulating electrode pairs is formed on the entire surface including the scan electrode 401 and the sustain electrode 403. Furthermore, a protection layer 408 having MgO deposited thereon is formed on a top surface of the upper dielectric layer 407 in order to facilitate discharge conditions.

At this time, the upper dielectric layer 407 has a differential thickness, and has a depressed portion of a predetermined depth at the center of the discharge cell. The dielectric layer is called the differential dielectric layer 407. The differential dielectric layer 407 can increase the intensity of an electric field generated when the plasma display panel is driven, which enables a greater amount of wall charges to be accumulated on the differential dielectric layer. Accordingly, driving voltage can be lowered at the time of plasma surface discharge, and therefore discharge efficiency can be improved.

However, in the plasma display panel employing the differential dielectric layer 407, a distance between the scan electrode 401 and an address electrode (not shown) is relatively wide. Accordingly, in a plasma display panel aiming at high definition, there is a limit to the improvement of characteristics of opposite discharge.

### SUMMARY

In one aspect, a plasma display panel comprises a scan electrode, a sustain electrode, and a barrier rib formed on a glass, and an upper dielectric layer having a differential thickness formed on the glass, the upper dielectric layer covering the scan electrode and the sustain electrode, wherein as the upper dielectric layer is far away from a discharge region portion between the scan electrode and sustain electrode, the width of the upper dielectric layer gradually increases, wherein a distance between the scan electrode and the sustain electrode positioned within a discharge cell partitioned by the barrier rib is more than a height of the barrier rib.

A difference in a height of the upper dielectric layer having the differential thickness may be set in the range of 1.2 to 2 times.

The upper dielectric layer having the differential thickness may comprise one or more auxiliary electrodes having a predetermined width and a predetermined thickness.

The width of the auxiliary electrode may be less than a long side in a length direction of the upper dielectric layer having the differential thickness. The thickness of the auxiliary electrode may be smaller than a thickness of the upper dielectric layer having the differential thickness.

The auxiliary electrode may be formed at the center of the upper dielectric layer having the differential thickness, and may be placed on the same line as that of the upper dielectric layer formed in the discharge region portion between the scan electrode and sustain electrode.

The distance between the scan electrode and the sustain electrode may range from 100 μm to 400 μm.

The distance between the scan electrode and the sustain electrode may range from 150 μm to 350 μm.

In another aspect, a plasma display panel, comprises a scan electrode, a sustain electrode, and a barrier rib formed on a glass, and an upper dielectric layer having a differential thickness formed on the glass, the upper dielectric layer covering the scan electrode and the sustain electrode, wherein a distance between the scan electrode and the sustain electrode located within a discharge cell partitioned by the barrier rib is more than a height of the barrier rib, wherein a thickness of a differential dielectric layer formed at a discharge gap between the scan electrode and the sustain electrode located within the discharge cell is more than a distance between transparent electrodes of the scan electrode and the sustain electrode, and is less than bus electrodes of the scan electrode and the sustain electrode.

A difference in a height of the upper dielectric layer having the differential thickness may range from 1.2 to 2 times.

The upper dielectric layer having the differential thickness may comprise one or more auxiliary electrodes having a predetermined width and a predetermined thickness.

The width of the auxiliary electrode may be less than a long side in a length direction of the upper dielectric layer having the differential thickness. The thickness of the auxiliary electrode may be smaller than a thickness of the upper dielectric layer having the differential thickness.

The auxiliary electrode may be formed at the center of the upper dielectric layer having the differential thickness, and may be placed on the same line as that of the upper dielectric layer formed in the discharge region portion between the scan electrode and sustain electrode.

The distance between the scan electrode and the sustain electrode may range from 100 μm to 400 μm.

The distance between the scan electrode and the sustain electrode may range from 150 μm to 350 μm.

A method of manufacturing a plasma display panel comprises forming a scan electrode and a sustain electrode on a glass, forming a first upper dielectric layer covering the scan electrode and the sustain electrode, and forming a second upper dielectric layer on the first upper dielectric layer.

Forming the first upper dielectric layer may include forming one or more auxiliary electrodes on the first upper dielectric layer.

### BRIEF DESCRIPTION OF THE DRAWINGS

The accompany drawings, which are included to provide a further understanding of the invention and are incorporated on and constitute a part of this specification, illustrate embodiments of the invention and together with the description serve to explain the principles of the invention.

FIG. 1 is a perspective view schematically showing the construction of a related art plasma display panel;

FIG. 2 is a flowchart illustrating a method of manufacturing the related art plasma display panel;

FIG. 3 is a cross-sectional view illustrating a method of manufacturing a front panel as an example of the related art plasma display panel;

FIG. 4 illustrates an upper dielectric layer having a differential thickness as an example of the related art plasma display panel;

FIG. 5 is a flowchart illustrating a method of manufacturing a plasma display panel according to an embodiment of the present invention;

FIG. 6 is a cross-sectional view illustrating a method of manufacturing a front panel of a plasma display panel according to a first embodiment;

FIG. 7 illustrates a differential dielectric layer of the plasma display panel illustrated in FIG. 6;

FIGS. 8a and 8b are cross-sectional views illustrating a method of manufacturing a front panel of a plasma display panel according to a second embodiment; and

FIG. 9 illustrates a differential dielectric layer comprising auxiliary electrodes of the plasma display panel illustrated in FIG. 8.

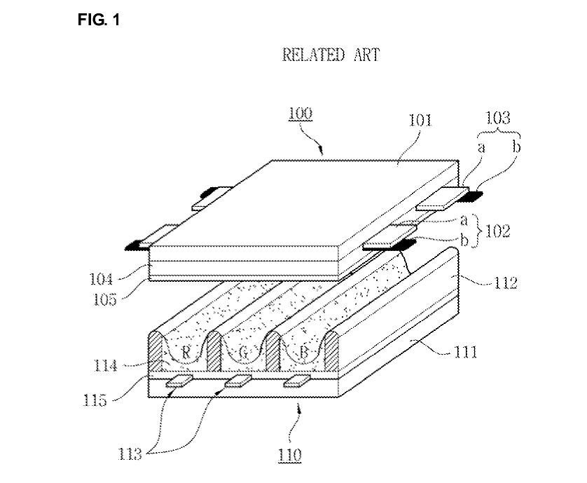

### DETAILED DESCRIPTION OF PREFERRED EMBODIMENTS

Reference will now be made in detail embodiments of the invention examples of which are illustrated in the accompanying drawings.

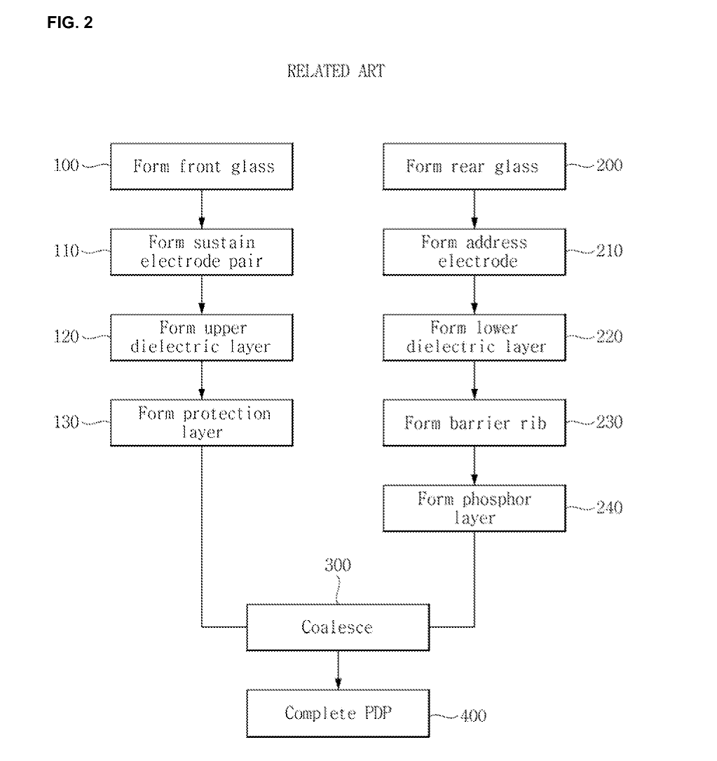

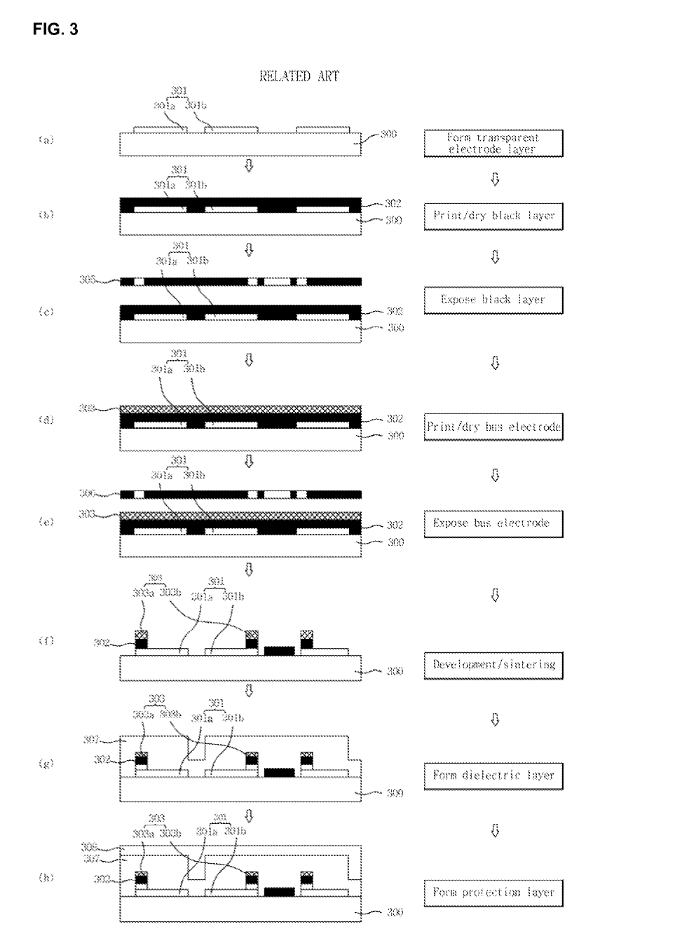

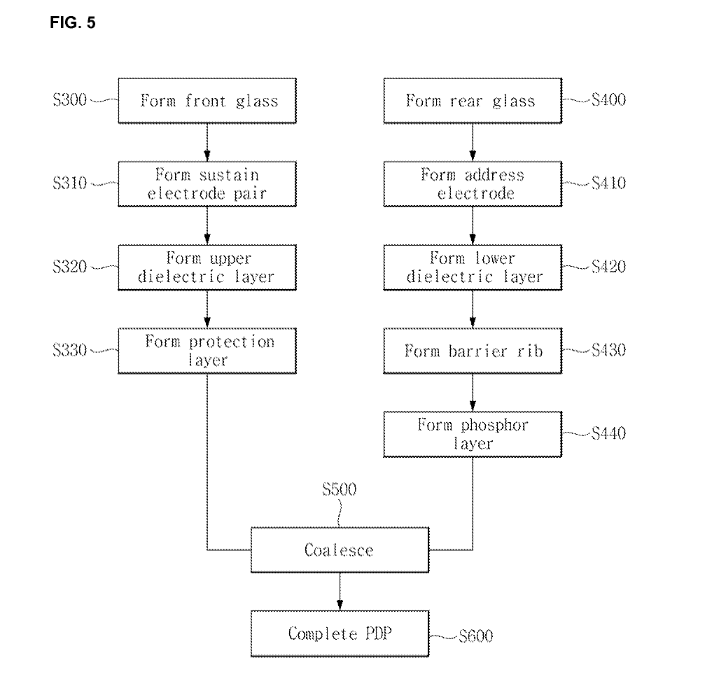

FIG. 5 is a flowchart illustrating a method of manufacturing a plasma display panel according to an embodiment of the present invention. The plasma display panel is formed through a sequential process in the same manner as that illustrated in FIG. 2.

As illustrated in FIG. 5, the method of manufacturing the plasma display panel comprises a front panel manufacturing process shown on the left side of FIG. 5, a rear panel manufacturing process shown on the right side of FIG. 5, and an assembly process comprising a sealing process, etc. shown at the bottom of FIG. 5.

In the front panel manufacturing process, after the front glass is prepared in step S300, the plurality of sustain electrode pairs are formed on the front glass in step S310. Thereafter, the upper dielectric layer is formed on the sustain electrode pairs in step S320. The protection layer made of MgO for protecting the sustain electrode pairs is formed on the upper dielectric layer in step S330.

In the rear panel, in the same manner as the front panel, the rear glass is first prepared in step S400. The plurality of address electrodes crossing the sustain electrode pairs formed in the front panel are formed in the rear glass in step S410. Thereafter, the lower dielectric layer is formed to cover the address electrodes in step 420. The barrier ribs are formed on a top surface of the lower dielectric layer in step 430. The phosphor layer is formed in the discharge spaces between the barrier ribs in step 440.

The front panel and the rear panel fabricated as described above are coalesced in step S500) to form the plasma display panel in step S600.

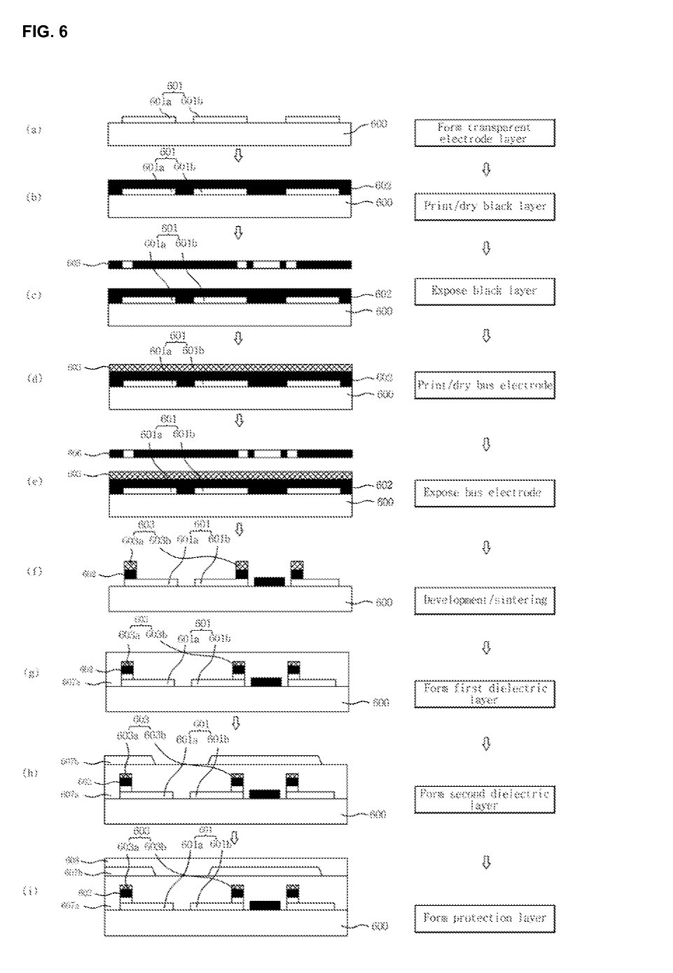

In the method of manufacturing the plasma display panel, the manufacturing process of the front panel is described in more detail below with reference to FIG. 6.

FIG. 6 is a cross-sectional view illustrating a method of manufacturing a front panel of a plasma display panel according to a first embodiment. An upper dielectric layer of the plasma display front panel has a differential height so that it is close to a lower dielectric layer of a rear panel. The upper dielectric layer having a differential height of the plasma display front panel is described below with reference to FIG. 6.

As illustrated in FIG. 6, at step (a), a transparent electrode 601 made of ITO comprising indium oxide and zinc oxide is formed on a front glass 600.

An example of a method of forming the transparent electrode 601 is described below. A DFR is laminated on the transparent electrode layer made of ITO to form a pattern of a photomask. Development and etching processes are performed to form a transparent electrode 601a for scan and a transparent electrode 601b for sustain.

At step (b), black paste for forming a black layer 602 is printed on the front glass 600 on which the transparent electrode 601a for scan and the transparent electrode 601b for sustain are formed. The black paste is dried at a temperature of about 120 degrees Celsius. At step (c), a photomask 605 having a pattern formed therein is placed on the dried black paste and is then dried by irradiating it with ultraviolet rays. This process is called photolithography.

At step (d), silver (Ag) paste 603 is coated and printed on the black layer 602 that has experienced the photolithography process in order to form bus electrodes 603a and 603b, and is then dried.

At step (e), a photomask 606 having a pattern formed therein is placed on the coated silver (Ag) paste 603 and experiences a photolithography process. At step (f), a portion of the coated silver (Ag) paste 603 that has not been hardened is developed and then sintered in a sintering furnace (not shown) at a temperature of about 550 degrees Celsius for about 3 hours, thus forming the bus electrode 603a for scan and the bus electrode 603b for sustain.

At step (g), a first upper dielectric layer 607a is formed on the front glass 600 on which the scan electrodes 601a and 603a and the sustain electrodes 601b and 603b are formed. Thereafter, at step (h), a second upper dielectric layer 607b having a pattern is formed on the first upper dielectric layer 607a. At this time, the second upper dielectric layer 607b is a differential dielectric layer, and gradually becomes thick while becoming more distant from the discharge region portion than the discharge region portion between the plurality of scan electrodes 601a and 603a and sustain electrodes 601b and 603b.

An example of a method of forming the upper dielectric layers 607a and 607b having a differential thickness is described below. A dielectric glass paste is coated and dried, and is then sintered in a temperature range of about 500 to 600 degrees Celsius, thus forming the upper dielectric layers.

At step (h), a protection layer 608 made of MgO is formed on a surface of the second upper dielectric layer 607b by means of a CVD method, an ion plating method, a vacuum deposition method or the like. The front panel of the plasma display panel is thereby completed.

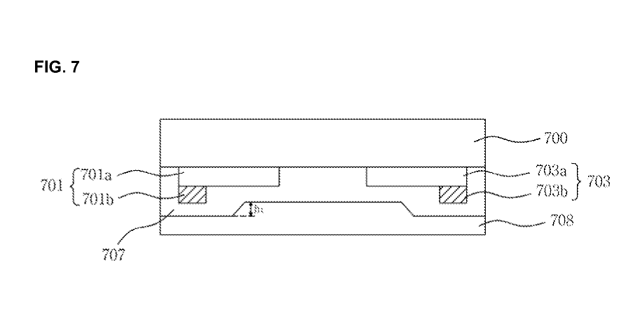

The differential dielectric layer, as an example of the plasma display front panel, is described in more detail below with reference to FIG. 7.

FIG. 7 is a view illustrating a differential dielectric layer of the plasma display panel illustrated in FIG. 6.

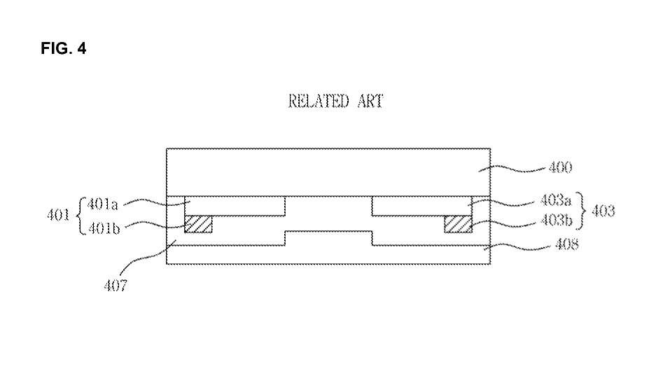

The plasma display panel according to the present embodiment is formed by the same method as that illustrated in FIG. 4. However, the upper dielectric layer of the plasma display panel according to the present embodiment becomes gradually thick while becoming more distant from the discharge region portion than the discharge region portion between the plurality of scan electrodes and the sustain electrodes.

The dielectric layer having a differential thickness, of the plasma display panel according to the present embodiment, is described in more detail below with reference to FIG. 7.

As illustrated in FIG. 7, a scan electrode 701 and a sustain electrode 703 are formed on a front glass 700. An upper dielectric layer 707 for limiting the discharge current between the scan electrode 701 and the sustain electrode 703 and insulating electrode pairs is formed on the entire surface including the scan electrode 701 and the sustain electrode 703. Furthermore, a protection layer 708 having MgO deposited thereon is formed on a top surface of the upper dielectric layer 707 in order to facilitate discharge conditions.

In this case, the upper dielectric layer 707 having a differential thickness becomes gradually thick while becoming more distant from the discharge region portion than the discharge region portion between the plurality of scan electrodes 701 and the sustain electrodes 703. It is preferred that a difference in a height h₁ of the upper dielectric layer 707 be set in the range of 1.2 to 2 times so that the upper dielectric layer 707 has a differential thickness.

The plasma display panel formed as described above can increase the intensity of an electric field generated when the panel is driven, so that a greater amount of wall charges can be accumulated on the panel. Accordingly, driving voltage at the time of plasma surface discharge can be lowered and discharge efficiency can be improved accordingly.

Further, the upper dielectric layer of the plasma display panel according to the present embodiment has a differential height so that a distance between the scan electrode and the address electrode is narrow. Accordingly, opposite discharge characteristics can be improved even in a plasma display panel aiming at high definition.

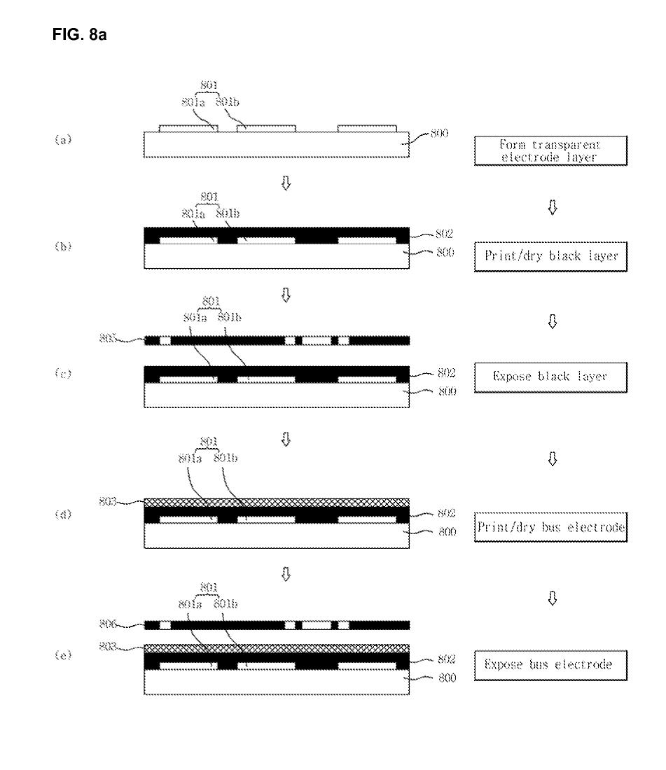

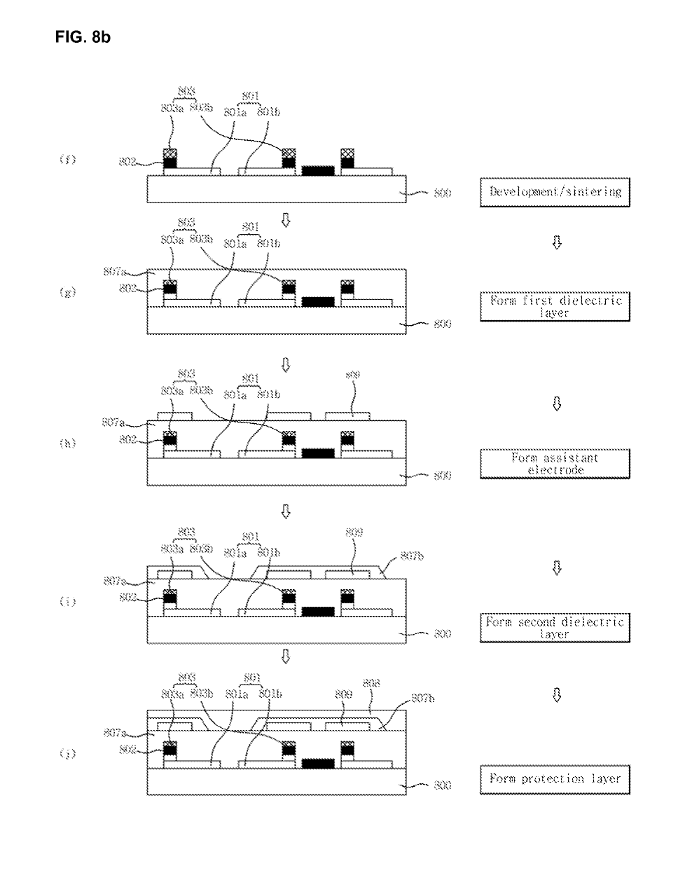

An example wherein the characteristics of surface discharge and opposite discharge can be further enhanced by improving the construction of the plasma display panel according to the present embodiment is described below with reference to FIG. 8.

FIGS. 8a and 8b are cross-sectional views illustrating a method of manufacturing a front panel of a plasma display panel according to a second embodiment.

An upper dielectric layer of a plasma display front panel according to the present embodiment has a differential height so that it is close to the lower dielectric layer of the rear panel in the same manner as that illustrated in FIG. 7. In the plasma display panel of the present embodiment, the upper dielectric layer having a differential thickness comprises one or more auxiliary electrodes having a width and thickness.

A method of forming one or more auxiliary electrodes in the upper dielectric layer having a differential thickness, of the plasma display front according to the present embodiment, is described below with reference to FIG. 8.

As illustrated in FIG. 8, at step (a), a transparent electrode 801 made of ITO comprising indium oxide and zinc oxide is formed on a front glass 800.

An example of a method of forming the transparent electrode 801 is described below. A DFR is laminated on the transparent electrode layer made of ITO to form a pattern of a photomask. Development and etching processes are performed to form a transparent electrode 801a for scan and a transparent electrode 801b for sustain.

At step (b), black paste for forming a black layer 802 is printed on the front glass 800 on which the transparent electrode 801a for scan and the transparent electrode 801b for sustain are formed. The black paste is dried at a temperature of about 120 degrees Celsius.

At step (c), a photomask 805 having a pattern formed therein is placed on the dried black paste and is then dried by irradiating it with ultraviolet rays. This process is called photolithography.

At step (d), silver (Ag) paste 803 is coated and printed on the black layer 802 that has experienced the photolithography process in order to form bus electrodes 803a and 803b, and is then dried.

At step (e), a photomask 806 having a pattern formed therein is placed on the coated silver (Ag) paste 803 and experiences a photolithography process.

At step (f), a portion of the coated silver (Ag) paste 803 that has not been hardened is developed and then sintered in a sintering furnace (not shown) at a temperature of about 550 degrees Celsius for about 3 hours, thus forming the bus electrode 803a for scan and the bus electrode 803b for sustain.

At step (g), a first upper dielectric layer 807a is formed on the front glass 800 on which the scan electrodes 801a and 803a and the sustain electrodes 801b and 803b are formed.

At step (h), one or more auxiliary electrodes 809 having a specific width and thickness are formed on the first upper dielectric layer 807a.

Thereafter, at step (i), a second upper dielectric layer 807b having a pattern and a differential thickness is formed to cover the auxiliary electrodes 809. At this time, the second upper dielectric layer 807b is a differential dielectric layer, and becomes gradually thick while becoming more distant from the discharge region portion than the discharge region portion between the plurality of scan electrodes 801a and 803a and sustain electrodes 801b and 803b.

An example of a method of forming the upper dielectric layers 807a and 807b having a differential thickness is described below. A dielectric glass paste is coated and dried, and is then sintered in a temperature range of about 500 to 800 degrees Celsius, thus forming the upper dielectric layers.

At step (i), a protection layer 808 made of MgO is formed on a surface of the second upper dielectric layer 807b by means of a CVD method, an ion plating method, a vacuum deposition method or the like. The front panel of the plasma display panel is thereby completed.

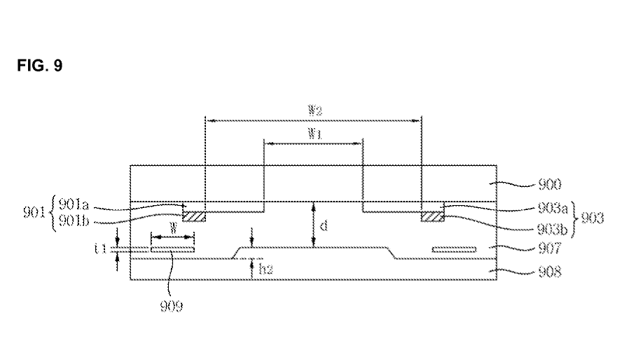

A method of forming one or more auxiliary electrodes in the differential dielectric layer, as an example of the plasma display front panel, is described in more detail below with reference to FIG. 9.

FIG. 9 is a view illustrating a differential dielectric layer comprising auxiliary electrodes of the plasma display panel illustrated in FIG. 8.

The plasma display panel according to the present embodiment is formed by the same method as that illustrated in FIG. 7. However, in the plasma display front panel of the present embodiment, one or more auxiliary electrodes are formed in a dielectric layer having a differential thickness. A method of forming one or more auxiliary electrodes in the dielectric layer having a differential thickness, of the plasma display panel according to the present embodiment, is described in more detail below with reference to FIG. 9.

As illustrated in FIG. 9, a scan electrode 901 and a sustain electrode 903 are formed on a front glass 900. An upper dielectric layer 907 having a differential thickness, for limiting the discharge current between the scan electrode 901 and the sustain electrode 903 and insulating electrode pairs is formed on the entire surface including the scan electrode 901 and the sustain electrode 903. A protection layer 908 having MgO deposited thereon is formed on a top surface of the upper dielectric layer 907 in order to facilitate discharge conditions.

At this time, the upper dielectric layer 907 having a differential thickness becomes gradually thick while becoming more distant from the discharge region portion than the discharge region portion between the plurality of scan electrodes 901 and the sustain electrodes 903. It is preferred that a difference in a height h₁ of the upper dielectric layer 907 be set in the range of 1.2 to 2 times so that the upper dielectric layer 807 has a differential thickness.

The plasma display panel according to the present embodiment further comprises one or more auxiliary electrodes 909, which respectively have a width W and a thickness t₁ and are formed in the upper dielectric layer 907 having a differential thickness. The auxiliary electrode 909 is formed at the center of the upper dielectric layer 907 having a differential thickness, and is placed on the same line as that of the upper dielectric layer 907 formed in the discharge region portion between the plurality of scan electrodes 901 and sustain electrodes 903.

More preferably, the width W of the auxiliary electrode 909 can be narrower than a long side in a length direction of the upper dielectric layer 907 having a differential thickness, and the thickness t₁ of the auxiliary electrode 909 can be smaller than a height h₂ of the upper dielectric layer 907 having a differential thickness. This results in an optimal condition for limiting the discharge current between the scan electrode 901 and the sustain electrode 903 and preventing the upper dielectric layer 907 from being broken.

The plasma display panel comprising the auxiliary electrodes provided in the differential dielectric layer formed as described above can increase the intensity of an electric field generated when the panel is driven, so that a greater amount of wall charges can be accumulated on the panel, in the same manner as the plasma display panel illustrated in FIG. 7. Accordingly, driving voltage at the time of plasma surface discharge can be lowered, and discharge efficiency can be improved accordingly.

Furthermore, the upper dielectric layer of the plasma display panel according to the present embodiment has a differential height such that a distance between the scan electrode and the address electrode is narrowed, and one or more auxiliary electrodes are further provided in the upper dielectric layer so that coupling with the scan electrodes and the sustain electrodes can occur. Accordingly, opposite discharge characteristics can be further improved even in plasma display panels aiming at high definition.

Further, though not illustrated in FIG. 9, a distance W1 between the scan electrode 901 and the sustain electrode 903, partitioned by the barrier rib and located within the discharge cell, can be wider than the height of the barrier rib. For example, the distance W1 between the scan electrode 901 and the sustain electrode 903 can be set in the range of 100 μm to 400 μm. A structure in which the distance W1 between the scan electrode 901 and the sustain electrode 903 is set in the range of 100 μm to 400 μm is called a long gap structure.

If a plasma display panel is formed to have the long gap structure in which the distance W1 between the scan electrode 901 and the sustain electrode 903 is set in the range of 100 μm to 400 μm as described above so that a positive column region of a discharge region can be employed, discharge efficiency of the plasma display panel can be maximized. Alternatively, the distance W1 between the scan electrode 901 and the sustain electrode 903 may be set in the range of 150 μm to 350 μm.

Further, as illustrated in FIG. 9, a thickness “d” of the differential dielectric layer formed at the discharge gap between the scan electrode 901 and the sustain electrode 903 located within the discharge cell can be set greater than a distance between the transparent electrodes 901a and 903a of the scan electrode and the sustain electrode, but smaller than a distance between the bus electrodes 901b and 903b of the scan electrode and the sustain electrode.

In this case, at the time of firing surface discharge between the transparent electrodes 901a and 903a of the scan electrode and the sustain electrode, a discharge path can be shortened and therefore a discharge firing voltage can be further lowered. Thus, the amount of voltage of a sustain waveform for sustain discharge can be lowered. Accordingly, since the plasma display panel of the long gap structure can be driven even without using an element having a good withstanding voltage in a circuit for supplying the sustain waveform, the manufacturing cost can be saved. Consequently, the efficiency of the long gap structure can be further improved since the upper dielectric layer is differentially formed in the plasma display panel of the long gap structure.

As described above, the surface discharge and the opposite discharge characteristics are improved by improving the structure of the dielectric layer of the front panel of the plasma display panel.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term “means” is explicitly recited in a limitation of the claims, such limitation is not intended to be interpreted under 35 USC 112(6).

What is claimed is:

1. A plasma display panel, comprising:
a scan electrode, a sustain electrode, and a barrier rib formed on a glass; and
an upper dielectric layer having a differential thickness formed on the glass, the upper dielectric layer covering the scan electrode and the sustain electrode,
wherein as the upper dielectric layer is far away from a discharge region portion between the scan electrode and sustain electrode, the width of the upper dielectric layer gradually increases,
wherein a distance between the scan electrode and the sustain electrode positioned within a discharge cell partitioned by the barrier rib is more than a height of the barrier rib.

2. The plasma display panel of claim 1, wherein a difference in a height of the upper dielectric layer having the differential thickness is set in the range of 1.2 to 2 times.

3. The plasma display panel of claim 2, wherein the upper dielectric layer having the differential thickness comprises one or more auxiliary electrodes having a predetermined width and a predetermined thickness.

4. The plasma display panel of claim 3, wherein the width of the auxiliary electrode is less than a long side in a length direction of the upper dielectric layer having the differential thickness, and
the thickness of the auxiliary electrode is smaller than a thickness of the upper dielectric layer having the differential thickness.

5. The plasma display panel of claim 4, wherein the auxiliary electrode is formed at the center of the upper dielectric layer having the differential thickness, and is placed on the same line as that of the upper dielectric layer formed in the discharge region portion between the scan electrode and sustain electrode.

6. The plasma display panel of claim 1, wherein the distance between the scan electrode and the sustain electrode ranges from 100 μm to 400 μm.

7. The plasma display panel of claim 1, wherein the distance between the scan electrode and the sustain electrode ranges from 150 μm to 350 μm.

8. A plasma display panel, comprising:
a scan electrode, a sustain electrode, and a barrier rib formed on a glass; and
an upper dielectric layer having a differential thickness formed on the glass, the upper dielectric layer covering the scan electrode and the sustain electrode,
wherein a distance between the scan electrode and the sustain electrode located within a discharge cell partitioned by the barrier rib is more than a height of the barrier rib, and
a thickness of a differential dielectric layer formed at a discharge gap between the scan electrode and the sustain electrode located within the discharge cell is more than a distance between transparent electrodes of the scan electrode and the sustain electrode, and is less than bus electrodes of the scan electrode and the sustain electrode.

9. The plasma display panel of claim 8, wherein a difference in a height of the upper dielectric layer having the differential thickness ranges from 1.2 to 2 times.

10. The plasma display panel of claim 8, wherein the upper dielectric layer having the differential thickness comprises one or more auxiliary electrodes having a predetermined width and a predetermined thickness.

11. The plasma display panel of claim 10, wherein
the width of the auxiliary electrode is less than a long side in a length direction of the upper dielectric layer having the differential thickness, and
the thickness of the auxiliary electrode is smaller than a thickness of the upper dielectric layer having the differential thickness.

12. The plasma display panel of claim 10, wherein the auxiliary electrode is formed at the center of the upper dielectric layer having the differential thickness, and is placed on the same line as that of the upper dielectric layer formed in the discharge region portion between the scan electrode and sustain electrode.

13. The plasma display panel of claim 8, wherein the distance between the scan electrode and the sustain electrode ranges from 100 μm to 400 μm.

14. The plasma display panel of claim 8, wherein the distance between the scan electrode and the sustain electrode ranges from 150 μm to 350 μm.

15. A method of manufacturing a plasma display panel, comprising:
forming a scan electrode and a sustain electrode on a glass;
forming a first upper dielectric layer covering the scan electrode and the sustain electrode; and
forming a second upper dielectric layer on the first upper dielectric layer.

16. The method of claim 15, wherein forming the first upper dielectric layer includes forming one or more auxiliary electrodes on the first upper dielectric layer.
